(19) United States
(12) Patent Application Publication
(10) Pub. No.: US 2004/0141748 A1
(43) Pub. Date: Jul. 22, 2004

(54) Use of coarse WDM channels for upstream traffic in fiber-to-the-home systems

(76) Inventors: Ralph Spickermann, Redwood City, CA (US); Steven R. Sakamoto, Santa Clara, CA (US); Masuma Ahmed, Palo Alto, CA (US)

Correspondence Address: Keith D. Nelson, Lockheed Martin Corporation, Building 220, Mail Stop A08, P.O. Box 49041, San Jose, CA, 95161-9041, US

(21) Appl. No.: 10/348,805

(22) Filed: Jan. 22, 2003

(51) Int. Cl. H04J 14/00

(52) U.S. Cl. 398/72

(57) ABSTRACT

Fiber-to-the-home communication systems and methods that use coarse wavelength-division-multiplexed (WDM) channels for upstream data traffic to increase the dedicated upstream data rate for each subscriber to greater than 10 Megabit/sec. Data for upstream transmission from the subscriber to a first location (central office) quadrature amplitude/phase shift key modulates a unique microwave carrier frequency. The modulated carrier frequency containing the upstream data intensity modulates the optical output of a laser operating at a unique optical wavelength. The subscriber optical signals at the second locations are combined and optically transmitted to a photodetector at the first location. The photodetector produces a composite microwave spectrum including all subscriber quadrature amplitude/phase shift keyed data spectra and low and high frequency inter-subscriber cross products. Because the optical wavelengths transmitted by the subscribers are at least 10 Gigahertz apart, all high frequency cross products produced by the photodetector are greater than the maximum subscriber unique microwave frequency. The low frequency cross products fall in the range from 0 Hertz to the maximum quadrature amplitude/phase shift keyed symbol rate. Thus, all cross products are filtered out by the subsequent frequency division demultiplexing of the individual subscriber data spectra. The individual subscriber quadrature amplitude/phase shift keyed data spectra are then demodulated to recover the original transmitted data.

### BACKGROUND

The present invention relates generally to fiber-to-the-home communication systems and methods, and more particularly, to the use of coarse wavelength-division-multiplexed (WDM) channels for upstream traffic in fiber-to-the-home communication systems.

Currently available fiber-to-the-home communication systems have an upstream channel that is limited to a relatively low data communication rate, typically on the order of 1.5 to 3 Megabit/sec. The data rate is limited because the wavelengths of the lasers used to transmit the subscriber upstream data signals are not controlled, and the lasers are simply modulated at baseband. Thus, in currently available systems, all subscribers need to timeshare the optical fiber medium to avoid interference. It would therefore be desirable to have a fiber-to-the-home communication system having a relatively high (10 Megabit/sec or greater guaranteed on demand) upstream data communication rate.

It is an objective of the present invention to provide for a fiber-to-the-home communication system and method that uses coarse WDM channels for upstream traffic to achieve a relatively high (10 Megabit/sec or greater guaranteed on demand) upstream data communication rate. It is an additional objective to achieve this without introducing additional expensive lasers and photodetectors beyond those required by currently available systems.

### SUMMARY OF THE INVENTION

To meet the above and other objectives, the present invention provides for fiber-to-the-home communication systems and methods that use coarse wavelength-division-multiplexed (WDM) channels for upstream data traffic. In the present systems and methods, a unique coarse WDM channel is assigned to each subscriber for upstream transmission. In addition, the optical carrier for each subscriber coarse WDM channel is amplitude modulated at a unique microwave carrier frequency. The microwave carrier is modulated with the data using an appropriate quadrature amplitude/phase shift keyed (QAM) technique. Each such channel is capable of data communication on the order of 10 Megabit/sec or greater. This is readily accomplished with currently available uncooled coarse WDM channel distributed feedback (DFB) semiconductor lasers, as the modulation bandwidth of these lasers is greater than 500 MHz. As will be described below, if the coarse WDM channels and their microwave carrier frequencies are suitably chosen, all subscribers may transmit at any time, and only one photodetector is required to receive all the subscribers' signals.

An exemplary fiber-to-the-home communication system comprises a neighborhood service provider unit in a central office (first location) and one or more subscribers in a remote neighborhood (each at a second location) that are interconnected by way of an optical fiber network. The optical fiber network includes a 1:n passive optical splitter/combiner that interconnects the neighborhood service provider unit to the n subscribers.

The neighborhood service provider unit at the central office comprises a downstream transmit laser (operating in a first waveband) and an optical amplitude modulator for amplitude modulating an optical carrier signal output of the transmit laser with downstream data. A coarse wavelength division multiplexer-demultiplexer is provided for use as a waveband directional coupler. This directs the amplitude modulated optical carrier signal onto the optical fiber to the subscribers for downstream transmission, and directs all the received simultaneous optical upstream data to a photodetector. This photodetector at the central office is used to recover and output the composite upstream data spectrum. The individual subscriber data streams are recovered from this composite spectrum by means of a microwave frequency division demultiplexer and individual demodulators.

The home unit at each subscriber location comprises a microwave carrier frequency source that operates at a unique microwave carrier frequency, a microwave modulator, and a laser at a unique coarse WDM wavelength (operating in a second waveband) for upstream transmission. The unique microwave carrier frequency for each subscriber is chosen such that it is sufficiently different from that of any other subscriber to avoid data spectrum overlap. The modulator is used to modulate the unique microwave carrier frequency signals with upstream data. The modulator encodes the data onto the microwave carrier in one of the many quadrature amplitude/phase shift key modulation (QAM) formats (ASK, BPSK, QPSK, 8 PSK, 16 QAM . . . ). One skilled in the art will incorporate the most appropriate QAM format according to the hardware cost and complexity, the amount of data to be transmitted per subscriber, the available electronic bandwidth and the link signal to noise ratio available. The home unit laser (that operates at a unique optical wavelength within the second waveband) is intensity modulated by the QAM modulated unique microwave carrier frequency signal. As in the neighborhood service provider unit, a coarse wavelength division multiplexer-demultiplexer is provided for use as a wavelength selective directional coupler. This coupler directs the amplitude modulated unique optical carrier signal onto the optical fiber for upstream transmission, and directs the received downstream optical data to a photodetector. The photodetector in the home unit is used to recover and output the downstream data. Note that all subscribers receive a copy of all downstream data. This consists of broadcast video and audio channels, to which all the users have access, as well as data addressed to the individual subscribers.

In an exemplary method, the downstream data that is to be transmitted from the first location (central office) to the second locations (subscribers) is used to amplitude modulate an optical carrier signal in a first wavelength band. The amplitude modulated optical carrier signal is routed for downstream transmission. The downstream optical carrier signal is optically transmitted to all the second locations (subscribers) by means of a 1:n optical splitter/combiner. The received optical carrier signal is routed to a photodetector. The optical carrier signal in the first wavelength band is detected to produce the downstream data.

Data that is to be transmitted upstream from the second location (subscriber) to the first location (central office) is used to QAM modulate a subscriber unique microwave carrier frequency. The modulated microwave carrier frequency containing the upstream data is filtered to suppress the secondary spectral data lobes. This filtered data spectrum intensity modulates the optical output of a laser operating at a subscriber unique optical wavelength in the second waveband. The optical output of the laser is routed for upstream transmission. The upstream optical signal is combined with all the other upstream optical signals by means of an 1:n passive optical splitter/combiner and then optically transmitted to the first location. The received composite optical signal is routed to a photodetector. The composite optical upstream signal, upon photodetection, produces a composite microwave data spectrum with each subscribers' data contained within a unique microwave subband. The individual subscriber's QAM data subbands are then electronically separated and demodulated to produce the original individual subscriber upstream data streams.

The present invention provides for greater than 10 Gigahertz separation in frequency between the subscriber optical carriers regardless of laser thermal frequency drift, so there is no interference between subscribers. The present invention also provides for sufficient separation in frequency between the associated microwave carriers so that there is no interference between the subscribers. The present invention enables each individual subscriber of the fiber-to-the-home communication system to economically have a dedicated upstream channel of at least 10 Megabit/sec.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates an exemplary fiber-to-the-home communication system implemented in accordance with the principles of the present invention;

FIG. 2 illustrates an exemplary upstream spectrum plan that may be employed in the system shown in FIG. 1;

FIG. 3 illustrates exemplary conservative and aggressive fiber-to-home wavelength channel designations that may be employed in the system shown in FIG. 1; and

FIG. 4 is a flow diagram illustrating an exemplary method in accordance with the principles of the present invention.

### DETAILED DESCRIPTION

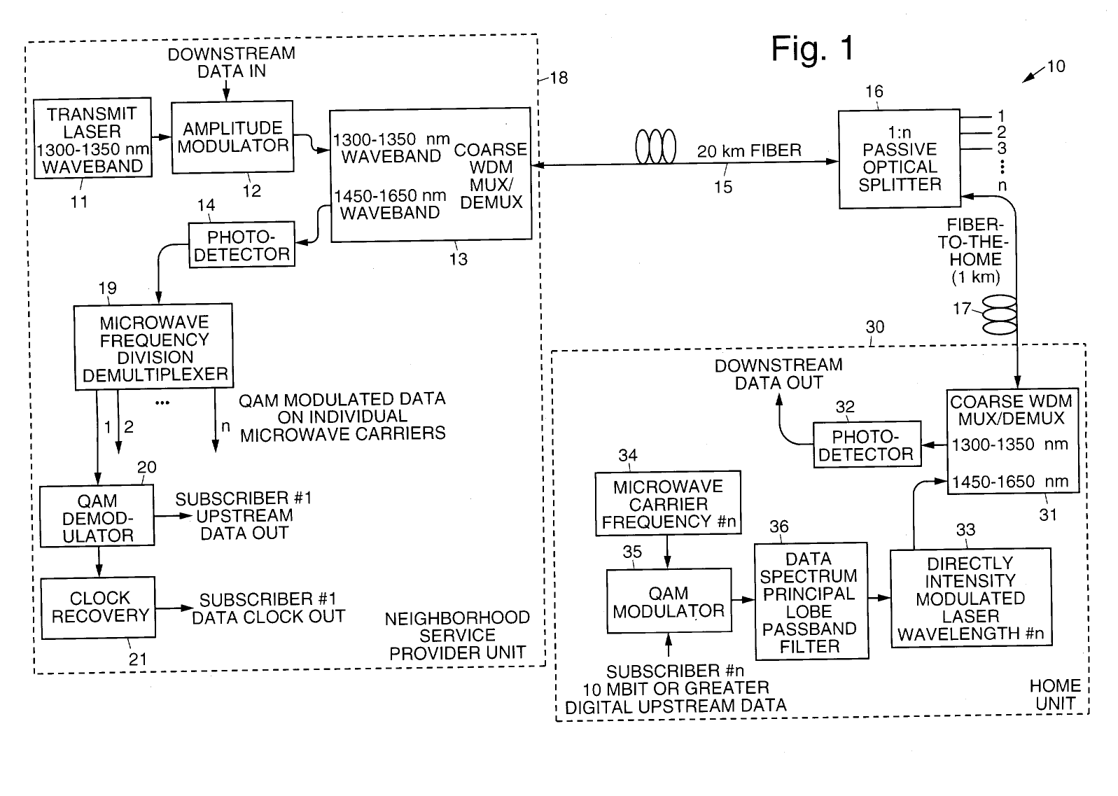

Referring to the drawing figures, FIG. 1 illustrates an exemplary fiber-to-the-home communication system 10 implemented in accordance with the principles of the present invention. The exemplary fiber-to-the-home communication system 10 comprises a neighborhood service provider unit 18 in a central office, a subscriber home unit 30 at each of the n subscriber locations, and a passive fiber optic network to interconnect them. A neighborhood service provider unit 18 services n subscribers in a remote neighborhood. There are many neighborhood service provider units 18 at a central office location.

The neighborhood service provider unit 18 includes a transmit laser 11, an amplitude modulator 12, a coarse wavelength division multiplexer-demultiplexer 13, a single photodetector 14, a microwave frequency division demultiplexer 19, a plurality (n) of microwave demodulators 20 and (n) corresponding data clock recovery units 21. The neighborhood service provider unit 18 is coupled by way of a first optical fiber 15 (having a length on the order of 20 kilometers) to a 1:n passive optical splitter/combiner 16. The 1:n passive optical splitter/combiner 16 splits the optical path into n optical fiber paths that are coupled to n home units 30 by individual lengths of second optical fiber 17 (having a length on the order of 1 kilometer).

At the neighborhood service provider unit 18, the transmit laser 11 preferably operates at a wavelength in the 1300-1350 nanometer (nm) waveband. The optical output of the transmit laser 11 provides a carrier signal that is coupled to the amplitude modulator 12. The amplitude modulator 12 amplitude modulates the carrier signal according to the downstream data signal. This downstream data is transmitted to all the subscribers. It includes broadcast video and audio channels to which all the subscribers have access as well as data addressed to the individual subscribers.

The amplitude modulated downstream data signal output of the amplitude modulator 12 is input to the coarse wavelength division multiplexer-demultiplexer 13. The coarse wavelength division multiplexer-demultiplexer 13 is used as a waveband selective directional coupler, and routes the amplitude modulated 1300-1350 nm waveband carrier signal containing the downstream data signals onto the first optical fiber 15.

The multiplexed signal is coupled to the 1:n passive optical splitter/combiner 16 which splits the signal into the n optical channels each of which are routed to a respective home unit 30 by way of the lengths of second optical fiber 17. Each length of second optical fiber 17 is coupled to a respective home unit 30.

Each home unit 30 comprises a coarse wavelength division multiplexer-demultiplexer 31, a photodetector 32, a microwave carrier frequency source 34, a QAM modulator 35, a principal data spectral lobe passband filter 36, and a unique coarse WDM laser 33. The coarse WDM laser 33 may be a distributed feedback (DFB) laser 33, a distributed Bragg reflector laser 33, or a vertical cavity surface laser 33, for example.

The coarse wavelength division multiplexer-demultiplexer 31 is used as a waveband selective directional coupler, which routes the 1300-1350 nm wavelength band amplitude modulated downstream signals into the photodetector 32 which outputs the recovered downstream data signals. Note that, as is currently common practice, all subscribers receive all downstream signals. An individual subscriber home unit extracts the particular subscriber's labeled data. This may be accomplished through many methods; this is current art and will not be discussed herein.

The microwave carrier frequency source 34 outputs a microwave carrier frequency of the particular home unit 30 (subscriber #n) to a first input of the QAM modulator 35. Subscriber #n upstream data is input to a second input of the QAM modulator 35. The output of the modulator 35 is filtered by the passband filter 36 to minimize spectral occupancy. The filtered spectrum intensity modulates the unique coarse WDM laser 33, which preferably operates at a wavelength in the 1450-1650 nm second waveband range and whose output is coupled to the coarse wavelength division multiplexer-demultiplexer 31 (used as an optical waveband selective directional coupler) in the home unit 30. The modulator 35 may be ASK, BPSK, QPSK, 8 PSK, 16 QAM, or higher order QAM. Practitioners well versed in communication systems will implement the best choice according to the cost, the data rate to be transmitted, the available electronic bandwidth, and the signal to noise ratio of the entire data link.

The intensity modulated output of the unique coarse WDM laser 33 containing the upstream data is routed to the upstream fiber 17 by the coarse wavelength division multiplexer-demultiplexer 31. At a suitable neighborhood location, the individual upstream signals from all the subscribers are combined onto one fiber by means of a 1:n passive optical splitter/combiner 16. This combined signal is sent further upstream over the optical fiber 15 to the coarse wavelength division multiplexer-demultiplexer 13 at the neighborhood service provider unit 18. The coarse wavelength division multiplexer-demultiplexer 13 routes the received signals to the photodetector 14 which recovers and outputs a composite microwave spectrum. This composite microwave spectrum contains the QAM modulated data spectra of all the subscribers' upstream data. Each subscriber's QAM data is on its unique microwave carrier frequency chosen such that there is no spectral interference between the subscriber's data. This composite spectrum is coupled into the microwave frequency division demultiplexer 19 which routes the individual QAM spectra to one of n QAM demodulators 20 and an associated data clock recovery unit 21. The demodulators 20 output the 10 Megabit/sec or greater upstream data transmitted by subscriber #n.

As in currently-available fiber-to-the-home systems, all the optical fiber 15, 17 in the system 10 simultaneously has two signals on it, namely “downstream” and “upstream” signals. These signals travel in opposite directions over the optical fiber 15, 17 in the two separate optical wavebands. The downstream signal travels from the neighborhood service provider unit 18 to the subscriber (home unit 30). The upstream data travels from the subscriber (home unit 30) to the central office 18. The promise of fiber-to-the-home communication systems 10 and its marketability has heretofore been limited by the speed of upstream data transmission. The present invention implements an economical upstream transmission technique.

The downstream signal is transmitted from the neighborhood service provider unit 18 on a 1300-1350 nm range wavelength laser signal. This downstream signal contains common data (such as TV signals) and also subbands for each subscriber's telephone and data. The downstream signal is split to n subscribers using the passive 1:n optical splitter/combiner 16. This downstream technique is similar to what is currently done.

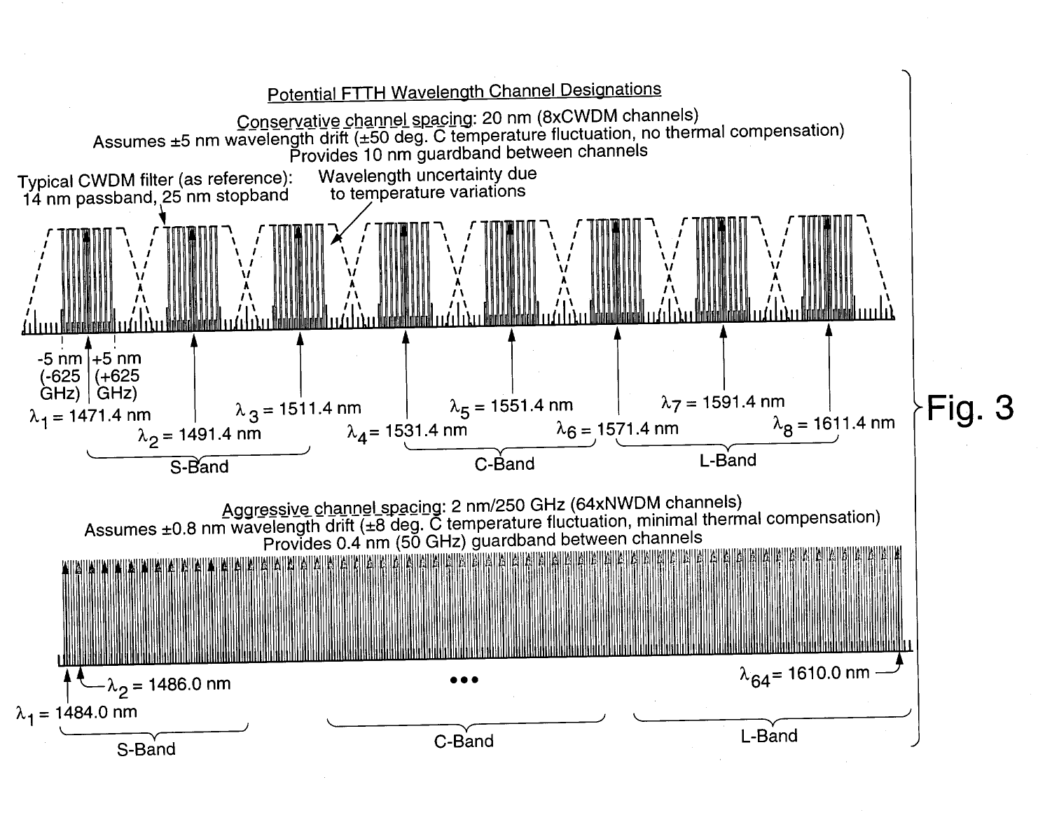

The novel aspects of the present invention are in the upstream communication link. Here, each subscriber (home unit 30) uses a laser 33 in the 1450-1650 nm waveband that has a unique coarse WDM wavelength relative to other users. Each individual wavelength is at least 10 Gigahertz different from any other user wavelength regardless of temperature variation and aging. This is illustrated in FIG. 3, which shows exemplary conservative and aggressive fiber-to-the-home wavelength channel designations that may be employed in the system 10.

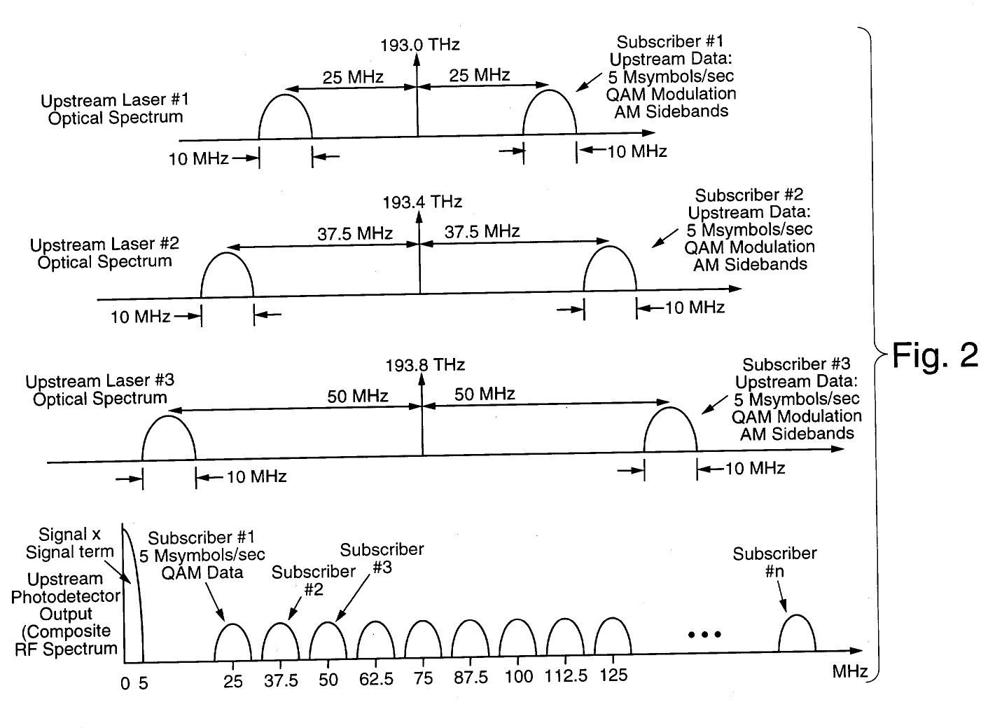

In addition to each subscriber home unit 30 having the laser 33 with a unique optical wavelength, each subscriber home unit 30 is assigned a unique microwave carrier frequency that is modulated with the upstream data. This QAM modulated microwave carrier is used to directly modulate the optical carrier output of the laser 33. This is illustrated in FIG. 2, which shows an exemplary upstream spectrum plan that may be employed in the system 10. Note that the set of upstream optical wavelengths and their associated microwave carrier frequencies may be reused for each set of n subscribers serviced by a neighborhood service provider unit and its associated passive 1:n optical splitter/combiner 16 in the field. The central office facility will generally consist of many neighborhood service provider units.

The optical signals output by the unique coarse WDM laser 33 are transmitted back upstream through the passive optical splitter 16 (which combines as well as it splits the signals) to the single photodetector 14 at the neighborhood service provider unit 18. The spectrum that emerges out of the single photodetector 14 at the neighborhood service provider unit 18 is shown at the bottom of FIG. 2. Each subscriber's QAM modulated data spectrum is output on the microwave carrier frequency with which the unique coarse WDM laser 33 was modulated at the subscriber home unit 30. There is no crosstalk because the optical wavelength of each subscriber is at least 10 Gigahertz different from any other, and their respective microwave carrier frequencies are chosen such that there is no microwave spectral overlap. FIG. 3 illustrates exemplary conservative and aggressive fiber-to-the-home wavelength channel designations to maintaining this 10 GHz spacing according to the amount of laser thermal control employed. Due to the 10 GHz minimum optical wavelength spacing, all photodetection produced electrical cross-products fall beyond the maximum frequency response of the photodetector 14. There is low frequency crosstalk around zero Hertz, but the minimum microwave carrier frequency is chosen to be greater than this. The total subscriber upstream capacity is determined by the maximum modulation bandwidth of the unique coarse WDM lasers 33 and the QAM modulation format chosen. In other words, given a subscriber upstream data rate, the QAM format determines the microwave bandwidth compression. This governs how many subscribers can operate within the DFB laser modulation bandwidth. The composite spectrum output by the photodetector 14 in the neighborhood service provider unit 18 can then be frequency division demultiplexed 19 into the individual QAM data spectra and the upstream data recovered therefrom (20-21).

In this way, by presorting the upstream transmission unique coarse WDM lasers 33 to fall into certain coarse WDM optical wavelength channels, and assigning each subscriber home unit 30 a unique microwave subcarrier with which to modulate the unique coarse WDM laser 33, each subscriber home unit 30 is given a dedicated channel capacity while requiring only one photodetector in the neighborhood service provider unit 18.

This is in contrast to the currently-available systems, where the wavelengths of the lasers used to transmit the subscriber upstream data signals are not controlled and the lasers are simply modulated at baseband. Thus, in currently-available systems, all subscribers need to timeshare the optical fiber medium to avoid interference. In addition, since no additional electro-optic parts (lasers, photodetectors) are required in the present invention compared to currently-available systems, the costs are comparable.

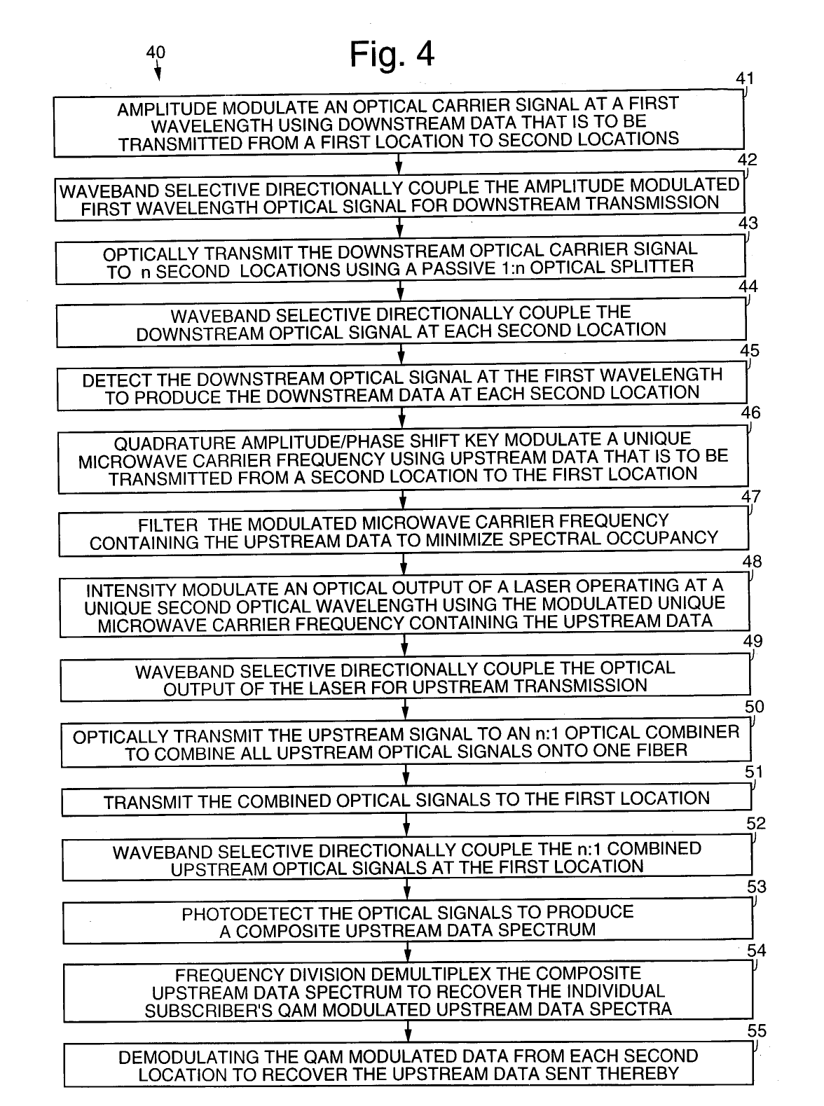

FIG. 4 is a flow diagram illustrating an exemplary method 40 in accordance with the principles of the present invention for communicating over fiber-to-the-home communication systems 10. The exemplary method 40 comprises the following steps.

Downstream data that is to be transmitted from a first location (central office) to n second locations (subscribers) is used to amplitude modulate 41 an optical carrier signal at a first wavelength. The amplitude modulated optical carrier signal is waveband selectively directionally coupled 42 for downstream transmission. The directionally coupled downstream optical signal is optically transmitted 43 to all subscriber locations by means of a 1:n passive optical splitter/combiner. The received optical carrier signal is waveband directionally coupled 44 and detected 45 by a photodetector to produce the downstream data.

In accordance with the present invention, upstream data that is to be transmitted upstream from the second location (subscriber) to the first location (central office/home unit) is used to QAM modulate 46 a unique microwave carrier frequency. The modulated microwave carrier frequency containing the upstream data is filtered 47 to minimize spectral occupancy. The filtered upstream data intensity modulates 48 the optical output of a laser operating at a unique coarse WDM optical wavelength in the second optical waveband. The optical output of the laser is waveband selectively coupled 49 for upstream transmission. The directionally coupled signal is optically transmitted 50 to a 1:n optical splitter/combiner, which combines all the subscriber upstream signals onto one fiber. The combined upstream optical signals are transmitted 51 to the first location. The received n:1 combined upstream optical signal is waveband selective directionally coupled 51 to a photodetector. The photodetector produces 52 the composite microwave upstream data spectrum. The composite microwave upstream data spectrum is microwave frequency division demultiplexed to recover 53 the individual subscribers' QAM modulated upstream data spectrum. This step also filters out all low and high frequency photodetection cross products. Each subscriber's QAM modulated data signal is then demodulated 54 to recover the individual subscriber upstream data streams.

Thus, fiber-to-home communication systems and methods that use coarse wavelength-division-multiplexed channels to achieve 10 Megabit/sec or greater of guaranteed upstream traffic have been disclosed.

Fiber-to-the-home communication systems and methods that use coarse wavelength-division-multiplexed channels for upstream data traffic to increase the dedicated upstream data rate for each subscriber to greater than 10 Megabit/sec without the introduction of additional expensive lasers and photodetectors have been disclosed. In the systems and methods, a unique upstream coarse wavelength-division-multiplexed channel is assigned to each subscriber, each at a second location. In addition, the optical carrier for each wavelength-division-multiplexed upstream channel is modulated at a unique microwave frequency.

Each of the channels is capable of data communication of 10 Megabit/sec or greater. Data that is to be transmitted upstream from the subscriber to a first location (central office) is used to quadrature amplitude/phase shift key modulate a unique microwave carrier frequency. The modulated microwave carrier frequency containing the upstream data intensity modulates the optical output of a laser operating at a unique optical wavelength. All of the subscriber optical signals at the second locations are combined and optically transmitted to the first location and coupled into a photodetector. The photodetector produces a composite microwave spectrum consisting of all the subscriber quadrature amplitude/phase shift keyed data spectra and low and high frequency inter-subscriber cross products. Because the optical wavelengths transmitted by the subscribers are at least 10 Gigahertz apart, all high frequency cross products produced by the photodetector are greater than the 500 Megahertz maximum subscriber unique microwave frequency. The low frequency cross products fall in the range from 0 Hertz to the maximum quadrature amplitude/phase shift keyed symbol rate, typically 10 Megasymbols/sec. Thus, all cross products are filtered out by the subsequent frequency division demultiplexing of the individual subscriber data spectra. The individual subscriber quadrature amplitude/phase shift keyed data spectra are then demodulated to recover the original transmitted data.

It is to be understood that the described embodiments are merely illustrative of some of the many specific embodiments which represent applications of the principles of the present invention. Clearly, numerous and other arrangements can be readily devised by those skilled in the art without departing from the scope of the invention.

What is claimed is:

1. A fiber-to-the-home communication system comprising:
a plurality of home units that each comprise optical apparatus for generating and transmitting a unique wavelength optical carrier for the respective home unit and that is modulated by a quadrature amplitude/phase shift keyed modulated unique frequency microwave carrier that is separated from the microwave carriers of the other home units, which modulated microwave carrier is electrically modulated by subscriber upstream data;
a plurality of optical fibers individually coupled to respective ones of the plurality of home units; and
a neighborhood service provider unit optically coupled to the plurality of optical fibers that comprises optical apparatus including a single photodetector for recovering and outputting a composite microwave spectrum comprising subscriber upstream data derived from each of the plurality of home units.

2. The system recited in claim 1 wherein the neighborhood service provider unit further comprises:
a transmit laser operating in a first optical waveband, an amplitude modulator for amplitude modulating an optical carrier output of the transmit laser with downstream data, a coarse wavelength division multiplexer-demultiplexer for routing the amplitude modulated carrier containing the downstream data onto a first optical fiber for downstream transmission to subscriber units, a microwave frequency division demultiplexer for outputting individual QAM spectra derived from the composite microwave spectrum, a plurality (n) of microwave demodulators for outputting upstream data transmitted by corresponding subscribers, and a plurality (n) of data clock recovery units coupled to corresponding ones of the microwave demodulators for outputting data clock signals of corresponding subscribers; and
a 1:n passive optical splitter/combiner for coupling optical signals between the first optical fiber and a plurality of second optical fibers routed to the subscriber units.

3. The system recited in claim 2 wherein the one or more home units each comprise:
a coarse wavelength division multiplexer-demultiplexer for routing the amplitude modulated downstream data to a home unit photodetector that outputs the recovered downstream data, a microwave carrier frequency source for outputting a unique microwave carrier frequency of the corresponding home unit, a QAM modulator for modulating the unique microwave carrier frequency with subscriber upstream data, a principal data spectral lobe passband filter, and a laser operating in a second optical waveband whose optical output is intensity modulated by the modulated unique microwave carrier frequency comprising the subscriber upstream data, which optical output is coupled to the coarse wavelength division multiplexer-demultiplexer for upstream transmission.

4. The system recited in claim 2 wherein the first optical fiber has a length on the order of ten kilometers.

5. The system recited in claim 2 wherein the individual lengths of second optical fibers are on the order of tewnty kilometer.

6. The system recited in claim 2 wherein the laser comprises a distributed feedback laser.

7. The system 10 recited in claim 2 wherein the laser comprises a distributed Bragg reflector laser.

8. The system recited in claim 2 wherein the laser comprises a vertical cavity surface laser.

9. The system recited in claim 1 wherein the coarse wavelength division multiplexer-demultiplexers comprises waveband selective directional couplers.

10. The system recited in claim 2 wherein the first optical waveband is from 1300 nanometers to 1350 nanometers.

11. The system recited in claim 3 wherein the second optical waveband is from 1450 nanometers to 1650 nanometers.

12. A method for communicating over a fiber-to-the-home communication system comprising a plurality of home units individually coupled by way of a plurality of optical fibers to a neighborhood service provider unit, the method comprising the steps of:
at each home unit, quadrature amplitude/phase shift key modulating a unique microwave carrier frequency using upstream data that is to be transmitted to the neighborhood service provider unit;
at each home unit, intensity modulating an optical signal at a unique optical wavelength using the modulated microwave unique carrier frequency containing the upstream data;
at each home unit, optically transmitting the intensity modulated optical signal containing the upstream data to the neighborhood service provider unit;
coupling the intensity modulated optical signals from all home units to a single photodetector to recover and output a composite microwave spectrum comprising subscriber upstream data derived from each of the home units.

13. The method recited in claim 12 further comprising the steps of:
passband filtering the unique modulated microwave carrier to minimize spectral occupancy.

14. The method recited in claim 12 wherein the unique optical wavelength is between 1450 nanometers and 1650 nanometers.

15. A method for communicating over a fiber-to-the-home communication system, comprising the steps of:
amplitude modulating an optical carrier signal at a first wavelength using downstream data that is to be transmitted from a first location to n second locations;
waveband selective directionally coupling the amplitude modulated optical carrier signal for downstream transmission;
optically transmitting the directionally coupled downstream optical carrier signal to n locations by means of a passive 1:n optical splitter;
waveband selective directionally coupling the downstream optical carrier signal at each location;
detecting the directionally coupled optical carrier signal at the first wavelength to produce the downstream data at each second location;
quadrature amplitude/phase shift key modulating a unique microwave carrier frequency using upstream data that is to be transmitted from a second location to a first location;
passband filtering the unique modulated microwave carrier to minimize spectral occupancy;
intensity modulating an optical output of a laser operating at a unique second optical wavelength using the modulated microwave unique carrier frequency containing the upstream data;
waveband selective directionally coupling the optical output of the laser for upstream transmission;
optically transmitting the directionally coupled upstream signal to the first location by means of an n:1 optical combiner;
combining in the n:1 combiner all n unique optical wavelength signals from the n second locations;
wavelength band selective directionally coupling the n:1 combined upstream optical signals at the first location;
detecting the directionally coupled carrier signals to produce the composite upstream data spectrum;
frequency division demultiplexing the composite upstream data spectrum to recover the individual subscribers' QAM modulated upstream data spectrum; and
demodulating each subscribers' QAM modulated data to recover the original data.

16. The method recited in claim 15 wherein the demodulating step recovers the original data and clock signals.
